(19) United States
(12) Patent Application Publication
(10) Pub. No.: US 2007/0218743 A1
(43) Pub. Date: Sep. 20, 2007

(54) Sliding prong-lock secondary lock

(76) Inventors: Gregory Phillip Ruhlander, Hannibal, MO (US); Donald Gene Gordy, Moberly, MO (US)

Correspondence Address: PORTER WRIGHT MORRIS & ARTHUR LLP;Attorneys & Counselors at Law, 41 South High Street, Columbus, OH, 43215-6194, US

(21) Appl. No.: 11/375,713

(22) Filed: Mar. 14, 2006

(51) Int. Cl. H01R 13/627

(52) U.S. Cl. 439/352

(57) ABSTRACT

An end fitting assembly for a motion transmitting cable includes an end fitting having a horizontal central longitudinal axis and a pair of laterally spaced-apart prongs substantially parallel to the central longitudinal axis and resiliently deflectable inward toward one another, a support bracket having an opening coaxially receiving the end fitting and a slot extending from the opening to a top edge of the support bracket for insertion of the end fitting into the opening, and a sliding secondary lock movable between a first position wherein the prongs are inwardly deflectable and a second position wherein the sliding secondary lock engages the prongs to wedge the prongs into engagement with the support bracket and prevent inward deflection of the prongs. The sliding secondary lock has a locking tab engaging the end fitting when the sliding secondary lock is in the second position to secure the sliding secondary lock in the second position.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to motion-transmitting remote control cable assemblies and, more particularly, to means for locking end fittings to support structures.

### BACKGROUND OF THE INVENTION

Motion-transmitting remote control cable assemblies, sometimes referred to as “Bowden cables” or “push-pull cables,” are used for transmitting both force and travel along a curved path in aircraft, automotive, and marine environments. Known cable assemblies can be used for transmitting load and motion in both push and pull type applications. In the automotive environment, typical applications include but are not limited to parking brakes, accelerators, hood releases, brake releases, trunk releases, park locks, tilt wheel controls, fuel filler doors, transmission shifter cables, and hydraulic control cables. One specific use of such remote control cable assemblies is positioning transmission shift members in automobiles.

A motion-transmitting remote control cable assembly for transmitting motion along a curved path typically includes a flexible core element (strand) slidably enclosed within a flexible outer sheath (conduit) with end fittings attached to both ends of each respective member. These fittings attach to and react load from the conduit to its mounting points and from the strand to its mounting points. The core element is adapted at one end to be attached to a member to be controlled whereas the other end is attached to an actuator for longitudinally moving the core element within the outer sheath. The outer sheath is adapted to be secured by the fittings to a support structure.

These fittings are provided with locks which secure the fittings to the support structure once installed. One approach has been to include a locking device having a sliding member that moves between a shipping or unlocked position and an installed or locked position. While these prior devices are at least somewhat effective at locking the assembly at normal operating conditions, they can fail when excessive extraction loads are applied. Accordingly, there is a need in the art for an improved locking device for a motion transmitting remote control cable assembly.

### SUMMARY OF THE INVENTION

The present invention provides a locking device for a motion-transmitting remote-control cable assembly which overcomes at least some of the above-noted problems of the related art. According to the present invention, an end fitting assembly for a motion transmitting cable comprises, in combination, an end fitting having a central longitudinal axis and a pair of laterally spaced-apart prongs substantially parallel to the central longitudinal axis and resiliently deflectable inward toward one another, and a sliding secondary lock movable between a first position wherein the prongs are inwardly deflectable and a second position wherein the sliding secondary lock engages the prongs to prevent inward deflection of the prongs.

According to another aspect of the present invention, an end fitting assembly for a motion transmitting cable comprises, in combination, an end fitting having a central longitudinal axis and a pair of laterally spaced-apart prongs substantially parallel to the central longitudinal axis and resiliently deflectable inward toward one another, a support bracket having an opening coaxially receiving the end fitting and a slot extending from the opening to an edge of the support bracket for insertion of the end fitting into the opening, and a sliding secondary lock movable between a first position wherein the prongs are inwardly deflectable and a second position wherein the sliding secondary lock engages the prongs to wedge the prongs into engagement with the support bracket and prevent inward deflection of the prongs.

According to yet another aspect of the present invention, an end fitting assembly for a motion transmitting cable comprises, in combination, an end fitting having a horizontal central longitudinal axis and a pair of laterally spaced-apart prongs substantially parallel to the central longitudinal axis and resiliently deflectable inward toward one another, a support bracket having an opening coaxially receiving the end fitting and a slot extending from the opening to a top edge of the support bracket for insertion of the end fitting into the opening, and a sliding secondary lock movable between a first position wherein the prongs are inwardly deflectable and a second position wherein the sliding secondary lock engages the prongs to wedge the prongs into engagement with the support bracket and prevent inward deflection of the prongs. The sliding secondary lock has a locking tab engaging the end fitting when the sliding secondary lock is in the second position to secure the sliding secondary lock in the second position.

From the foregoing disclosure and the following more detailed description of various preferred embodiments it will be apparent to those skilled in the art that the present invention provides a significant advance in the technology of locking devices for motion-transmitting remote-control cable assemblies. Particularly significant is the illustrated relatively low cost, reliable, easily installed locking device for a motion-transmitting remote-control cable assembly which withstands relatively high extraction forces. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of an end fitting assembly for a motion transmitting remote control cable according a preferred embodiment of the present invention, wherein the fitting is inserted into and engagement plate or bracket and a sliding secondary lock is in a shipping or unlocked position;

FIG. 2 is another perspective view of the end fitting assembly of FIG. 1;

FIG. 3 is a perspective view of the end fitting assembly of FIGS. 1 and 2, wherein the sliding secondary lock is in an installed or locked position;

FIG. 4 is another perspective view of the end fitting assembly of FIGS. 1 to 3, wherein the sliding secondary lock is in an installed or locked position;

FIG. 5 is a perspective view of and end fitting of the end fitting assembly of FIGS. 1 to 4;

FIG. 6 is another perspective view of the end fitting of FIG. 5;

FIG. 7 is a perspective view of a sliding secondary lock of the end fitting assembly of FIGS. 1 to 4; and

FIG. 8 is another perspective view of the sliding secondary lock of FIG. 7.

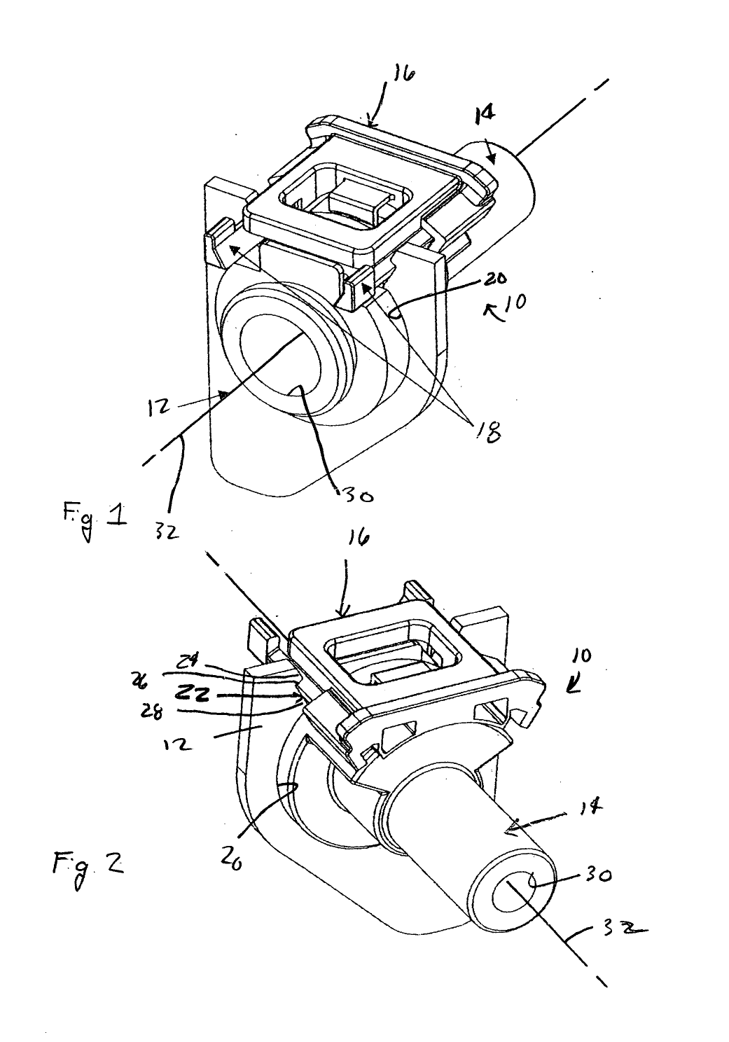

It should be understood that the appended drawings are not necessarily to scale, presenting a somewhat simplified representation of various preferred features illustrative of the basic principles of the invention. The specific design features of the end fitting assemblies for remote-control cables as disclosed herein, including, for example, specific dimensions, orientations, and shapes of the end fitting, sliding secondary lock, and engagement plate will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the end fitting assemblies illustrated in the drawings. In general, up or upward refers to an upward direction generally within the plane of the paper in FIGS. 1 to 4 and down or downward refers to a downward direction generally within the plane of the paper in FIGS. 1 to 4. Also in general, fore or forward refers to a direction toward the left generally within the plane of the paper in FIGS. 1 to 4 and aft or rearward refers to a direction toward the right generally within the plane of the paper in FIGS. 1 to 4.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved end fitting assemblies for motion-transmitting remote control cables disclosed herein. The following detailed discussion of various alternative and preferred embodiments will illustrate the general principles of the invention with reference to an end fitting assembly for a remote control cable of a motor vehicle transmission system. Other embodiments suitable for other applications will be apparent to those skilled in the art given the benefit of this disclosure.

Referring now to the drawings, FIGS. 1 to 4 show and end fitting assembly 10 for a remote control cable assembly of a motor vehicle transmission shift assembly, such as an automobile transmission shift assembly, according to a preferred embodiment of the present invention. While the illustrated embodiments of the present invention are particularly adapted for use with an automobile, it is noted that the present invention can be utilized with any motor vehicle having a control cable including trucks, buses, vans, recreational vehicles, earth moving equipment and the like, off road vehicles such as dune buggies and the like, air borne vehicles, and water borne vehicles. While the illustrated embodiments of the present invention are particularly adapted for use with a transmission shift assembly, it is also noted that the present invention can be utilized with other motor vehicle systems such as, for example, the parking brake, accelerator, hood release, brake release, trunk release, park lock, tilt wheel control, fuel filler door, and hydraulic control cables.

The illustrated end fitting assembly 10 secures one end of an outer sheath or conduit of a flexible motion-transmitting remote control cable to an engagement plate or support bracket 12 to substantially prevent motion therebetween. A flexible inner core or strand is longitudinally slidable within the conduit in a known manner to actuate a motor vehicle control member such as a pin of a motor vehicle transmission. The other end of the conduit and strand are operatively connected to an actuator such as a shifter mechanism so that selective operation of the actuator and resulting longitudinal movement of the strand actuates the control member. The flexible conduit and strand allow the remote-control cable assembly to be routed between the actuator and the control member along a desired path which is typically tortuous and nonlinear.

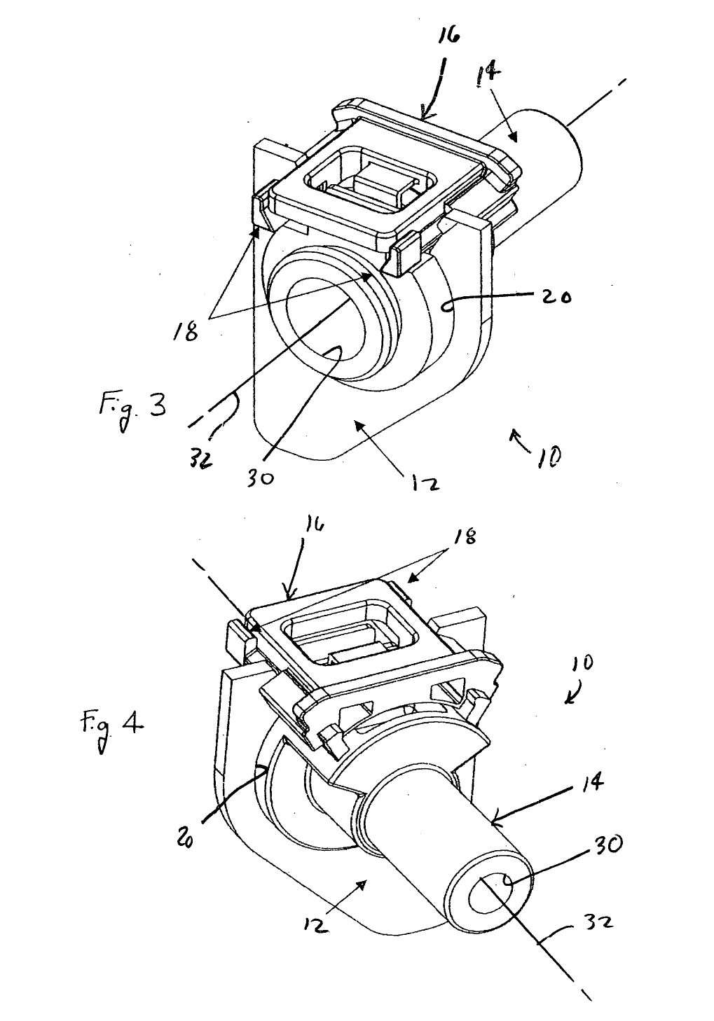

As shown in FIGS. 1 to 4, the end fitting assembly 10 includes an end fitting 14 and a sliding secondary lock or slider 16 which is selectively movable between a shipping or unlocked position wherein a primary lock 18 of the end fitting 14 is operable so that the end fitting 14 can be installed onto the support bracket 12 (shown in FIGS. 1 and 2) and an installed or locked position wherein the primary lock 18 cannot be unlocked and the primary lock 18 of the end fitting 14 and the secondary lock 16 each securely hold and lock the end fitting assembly 10 to the support bracket 12 (shown in FIGS. 3 and 4).

The illustrated engagement plate or support bracket 12 is a plate or sheet oriented in a vertical plane so that its opposed planar faces are facing in forward and rearward directions. The support bracket 12 has an opening 20 sized and shaped to receive and encircle the end fitting 16. The illustrated opening is circular-shaped but any other suitable shape can alternatively utilized. The opening 20 is smaller than adjacent portions of the end fitting 14 to limit forward and rearward movement of the end fitting 14 relative to the support bracket 12 when the end fitting 14 is located within the opening 20 as described in more detail hereinafter. The support bracket 12 forms a part of a support structure to support the remote-control cable assembly at a desired location. The support bracket 12 may be an arm of support or structure and may also be part of a bulkhead or panel through which the remote-control cable assembly extends.

A vertical slot 22 extends from the opening 20 to the top of the support bracket 20 so that the end fitting 14 can be downwardly inserted into the opening 20. The opposed sides of the slot 22 are sized and shaped to cooperate with the primary lock 18 of the end fitting 14. Each side of the illustrated slot 22 has first or camming portion 24, a second or abutment portion 26, and a third or engagement portion 28 (best shown in FIG. 2). The camming portion 24 is sized and shaped to inwardly cam the primary lock 18 of the end fitting 14 during installation of the end fitting 14 into the opening 20 as described in more detail hereinafter. The illustrated camming portion 24 is generally upward facing but forms an acute angle with horizontal. The abutment portion 26 is sized and shaped to prevent upward movement of the primary lock 18 of the end fitting 14 when the end fitting 14 is in the opening 20 as described in more detail hereinafter. The illustrated abutment portion 26 is generally downward facing but forms an acute angle with horizontal. The engagement portion 28 is sized and shaped to provide a bottom stop for the primary lock 18 of the end fitting 14 when the end fitting 14 is in the opening 20 as described in more detail hereinafter. The illustrated engagement portion 28 is generally upward facing but forms an acute angle with horizontal and is substantially parallel with the camming surface 24.

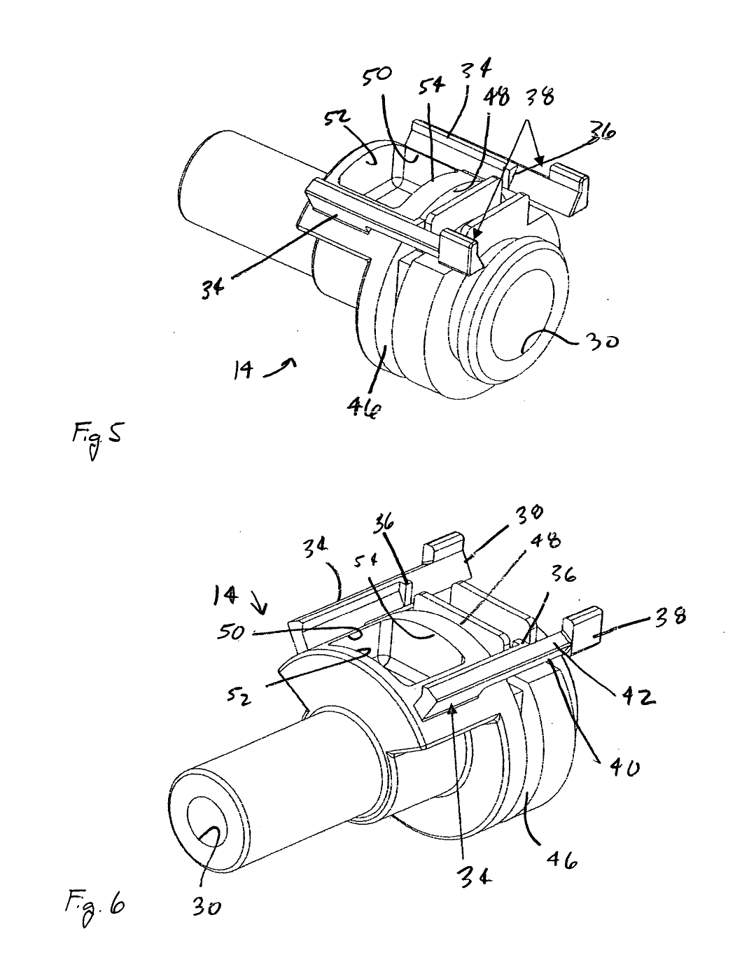

As best shown in FIGS. 5 and 6, the end fitting 14 is generally tubular shaped having a horizontal, longitudinally-extending passage 30 along a central longitudinal axis 32 for coaxially cooperating with the remote control cable. The end fitting 14 is preferably of unitary, that is one-piece, construction and molded of a suitable plastic material. It is noted, however, that the end fitting 14 can alternatively be of integral construction and/or formed at least partially of any other suitable materials. A pair longitudinally-extending keys or rails 34 are provided at the top of the end fitting 14 which cooperate with the sliding secondary lock 16 to orient the sliding secondary lock 16 relative to the end fitting 14 and permit horizontal, longitudinal sliding movement of the sliding secondary lock 16 along the top of the end fitting 14. The rails 34 are horizontal and laterally spaced apart. The illustrated rails 34 are generally rectangular-shaped in cross-section and radially-extending from the central axis 32 at an acute angle from horizontal. Tabs 36 are located on the rails 34 that form rearward facing abutment surfaces sized and shaped for engagement by the sliding secondary lock 16 to limit forward movement of the sliding secondary lock 16 along the top of the end fitting 14.

The end fitting 14 is also provided with the primary lock 18 in the form of a pair of longitudinally-extending, horizontal, and laterally spaced apart prongs 38. The illustrated prongs 38 are forwardly extending cantilevered extensions of the rails 34 that can be resiliently deflected in a laterally-inward direction during insertion of the end fitting 14 into the opening 20. The prongs 38 and the rails 34 are substantially parallel to the central axis 22 and the remote control cable therein. The prongs 38 are sized and shaped to cooperate with the slot 22 of the support bracket 12 to secure the end fitting 14 within the opening 20 as described in more detail hereinafter. The illustrated prongs 38 have a first or camming surface 40 and a second or abutment surface 42. The camming surface 40 is sized and shaped to cooperate with the camming portion 24 of the slot 22 to inwardly cam the prong 38 during installation of the end fitting 14 into the opening 20 as described in more detail hereinafter. The illustrated camming surface 40 is generally downward facing but forms an acute angle with horizontal. The abutment surface 42 is sized and shaped to engage the abutment portion 26 of the slot 22 to prevent upward movement of the prongs 38 out of the opening 20 when the end fitting 14 is in the opening 20 as described in more detail hereinafter. The illustrated abutment surface 42 is generally downward facing but forms an acute angle with horizontal. The illustrated forward end of the prongs 38 are provided with a pair of opposed laterally and inward facing tabs 44 sized and shaped to cooperate with the sliding secondary lock 16 to prevent inward deflection of the prongs 38 as described in more detail hereinafter.

A circumferential groove 46 is formed along the longitudinal length of the end fitting 14 that is sized and shaped for cooperation with the opening 20 of the support bracket 12. Opposed sides of the groove 46 are sized larger than the opening 20 to form opposed abutments that limit longitudinal movement of the end fitting 14 relative to the support bracket 12. The groove 46 is positioned longitudinally at the prongs 38. The top of the end fitting 14 is also provided with a forward facing abutment 48 longitudinally located at the groove 46. Rearward of the abutment 48 is a rectangular-shaped cavity 50 formed in the top of the end fitting 14 and forming opposed forward and rearward facing abutments 52, 54.

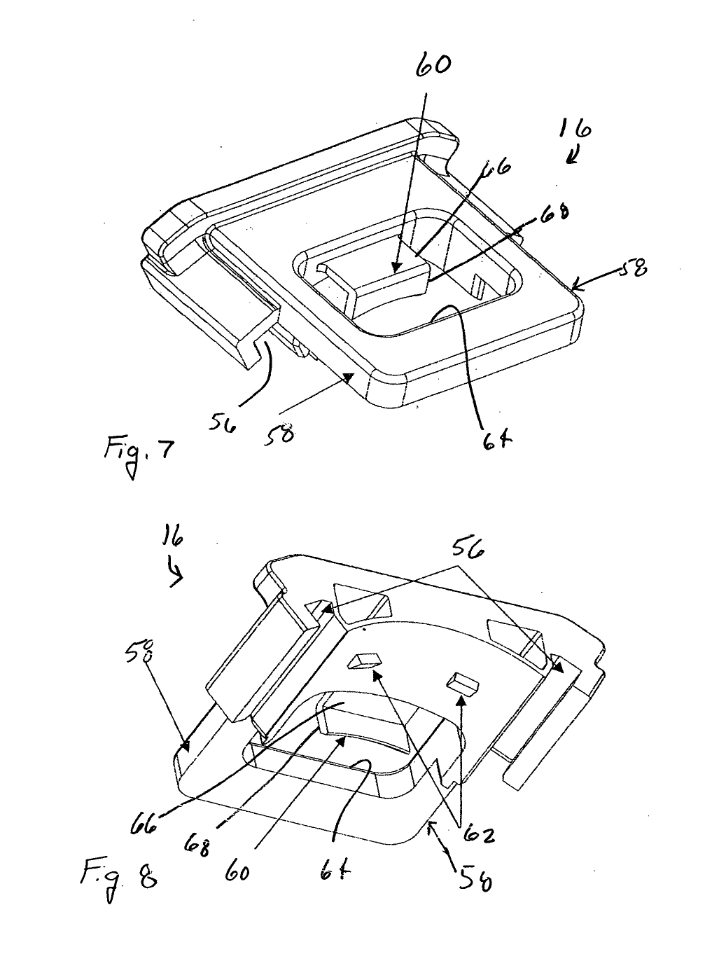

As best shown in FIGS. 7 and 8, the illustrated sliding secondary lock 16 is generally rectangular shaped. The sliding secondary lock 16 is preferably of unitary that is one-piece, construction and molded of a plastic material. It is noted, however, that the sliding secondary lock 16 can alternatively be of integral construction and/or formed at least partially of any other suitable materials. A pair of horizontal, laterally space-apart, and longitudinally extending key-ways or rail slots 56 is provided at lower side and rearward end of the sliding secondary lock 16. The rail slots 56 are sized and shaped to receive the rails 34 of the end fitting 14 for guiding the sliding secondary lock 16 between its storing and installed positions. The forward end of the sliding secondary lock 16 forms opposed, laterally-facing contact areas or abutments 58 that cooperate with the prong tabs 44 to prevent inward deflection of the prongs 38 when the sliding secondary lock 16 is in its installed position.

The illustrated sliding secondary lock 16 also includes a forward locking tab 60 and a pair of reverse locking tabs 62. The forward locking tab 60 is sized and shaped to cooperate with the groove abutment 48 to prevent rearward movement of the sliding secondary lock 16 when in the installed position. The illustrated sliding secondary lock 16 has an opening or passage 64 vertically extending therethrough. The forward locking tab 60 is located within the opening 64 and forwardly extends from a rearward end of the opening 64. The forward locking tab 60 has a forwardly extending horizontal portion 66 and a downwardly extending vertical portion 68 extending from the forward, free end of the horizontal portion 66 so that the forward locking tab 60 is resiliently deflectable in the vertical direction. A forward side of the vertical portion 68 is provided with an angled camming surface for upwardly deflecting the forward locking tab 60 upon forward movement of the sliding secondary lock 16 toward the installed position. A rearward side of the vertical portion 68 forms an abutment to prevent rearward movement of the sliding secondary lock 16 when the sliding secondary lock 16 is in the installed position. The illustrated reverse locking tabs 62 are located near the rearward end of the sliding secondary lock 16. The reverse locking tabs 62 are sized and shaped to cooperate with the rear end 52 of the cavity 50 to additionally prevent rearward movement of the sliding secondary lock 16 when in the installed position. A forward side of each tab 62 is provided with an angled camming surface for upwardly deflecting the lock 16 upon forward movement of the sliding secondary lock 16 toward the installed position. A rearward side of each tab 62 forms an abutment to prevent rearward movement of the sliding secondary lock 16 when the sliding secondary lock 16 is in the installed position.

As best shown in FIGS. 1 and 2, when it is desired to attach the end fitting assembly 10 to the support bracket 12, the groove 46 of the end fitting 14 is aligned with the slot 22 of the support bracket 12 and the end fitting 14 is downwardly moved into the opening 20 of the support bracket 12 through the slot 22. As this occurs, the prongs 38 are compressed inward upon cooperation of the camming surface 40 with the camming portion 24 and with further downward movement the prongs 38 resiliently deflect back once the end fitting 14 is in the opening 20. In this position, the abutment surface 42 engages the abutment portion 26 to limit vertical movement and prevent upward movement of the end fitting 14 vertically out of the opening 20 in the support bracket 12. The sides of the groove 46 engage the support bracket 14 to limit forward and rearward longitudinal movement of the end fitting relative 14 to the support bracket 12.

Once the end fitting 14 is secured to the support bracket 12 by the primary lock 18, the sliding secondary lock 16 is slid forward from its shipping position to its installed portion as shown in FIGS. 2 and 3. In the installed position, the contact areas 58 of the sliding secondary lock 16 are positioned at the prong tabs 44 to prevent inward deflection of the prongs 38 and thus removal of the end fitting 14 from the support bracket 12. The sliding secondary lock 16 is secured in position by the forward locking tab 60 and the reverse locking tabs 62. Upon forward movement of the sliding secondary lock 16, the forward locking tab 60 deflects upwardly as it engages the forward end 54 of the cavity 50 and resiliently snaps back downward when it is forward of the abutment 48. In the installed position, the forward locking tab 60 engages the abutment 48 to prevent rearward movement of the sliding secondary lock 16 out of the installed position. Also upon forward movement of the sliding secondary lock 16, the reverse locking tabs 62 deflect the lock 16 upwardly as it engages the end fitting end and the lock 16 resiliently snaps back downward when the tabs 62 are within the cavity 50. In the installed position, the reverse locking tabs 62 engage the abutment 52 at the rear end of the cavity 50 to additionally prevent rearward movement of the sliding secondary lock 16 out of the installed position.

It is apparent that the end fitting assembly of the present invention that the end fitting has horizontal prongs that parallel to the cable and perpendicularly engage the bracket to resiliently snap-in and the sliding lock horizontally slides along the prongs to form a wedge fit between the prongs and the bracket. Thus, the prongs interface with the sliding lock and the bracket. The sliding lock is designed to engage the prongs and the plate to directly react to extraction loads. Load paths are carried through the prongs and the sliding lock to maintain engagement with the plate. This type of engagement gives a tighter fit with the end fitting reducing system lash, raising extraction efforts and eliminating possible noise issues. The sliding lock also helps with partial installations of the end fitting. When the prongs are not fully engaged with the bracket, the sliding lock will have difficulty sliding forward. This will tell the operator there is a problem with the installation. Also, the sliding lock may push the prongs into their proper engagement.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An end fitting assembly for a motion transmitting cable comprising, in combination:
an end fitting having a central longitudinal axis and a pair of laterally spaced-apart prongs substantially parallel to the central longitudinal axis and resiliently deflectable inward toward one another; and
a sliding secondary lock movable between a first position wherein the prongs are inwardly deflectable and a second position wherein the sliding secondary lock engages the prongs to prevent inward deflection of the prongs.

2. The end fitting assembly according to claim 1, wherein the sliding secondary lock horizontally moves between the first and second positions.

3. The end fitting assembly according to claim 1, wherein the prongs and the central longitudinal axis are horizontal.

4. The end fitting assembly according to claim 1, wherein the end fitting has a pair of laterally spaced-apart rails and the sliding secondary lock has a pair of rail slots receiving the rails.

5. The end fitting assembly according to claim 1, wherein the sliding secondary lock has a locking tab engaging the end fitting when the sliding secondary lock is in the second position to secure the sliding secondary lock in the second position.

6. The end fitting assembly according to claim 5, wherein the sliding secondary lock has additional locking tabs engaging the end fitting when the sliding secondary lock is in the second position to additionally secure the sliding secondary lock in the second position.

7. The end fitting assembly according to claim 1, wherein the sliding secondary lock outwardly wedges the prongs when in the second position.

8. The end fitting assembly according to claim 1, further comprising a support bracket having an opening coaxially receiving the end fitting and a slot extending from the opening to an edge of the support bracket for insertion of the end fitting into the opening.

9. The end fitting assembly according to claim 8, wherein the slot extends to a top of the support bracket and the prongs are substantially perpendicular to the slot.

10. An end fitting assembly for a motion transmitting cable comprising, in combination:
an end fitting having a central longitudinal axis and a pair of laterally spaced-apart prongs substantially parallel to the central longitudinal axis and resiliently deflectable inward toward one another;
a support bracket having an opening coaxially receiving the end fitting and a slot extending from the opening to an edge of the support bracket for insertion of the end fitting into the opening; and
a sliding secondary lock movable between a first position wherein the prongs are inwardly deflectable and a second position wherein the sliding secondary lock engages the prongs to wedge the prongs into engagement with the support bracket and prevent inward deflection of the prongs.

11. The end fitting assembly according to claim 10, wherein the sliding secondary lock horizontally moves between the first and second positions.

12. The end fitting assembly according to claim 10, wherein the prongs and the central longitudinal axis are horizontal.

13. The end fitting assembly according to claim 10, wherein the end fitting has a pair of laterally spaced-apart rails and the sliding secondary lock has a pair of rail slots receiving the rails.

14. The end fitting assembly according to claim 10, wherein the sliding secondary lock has a locking tab engaging the end fitting when the sliding secondary lock is in the second position to secure the sliding secondary lock in the second position.

15. The end fitting assembly according to claim 14, wherein the sliding secondary lock has additional locking tabs engaging the end fitting when the sliding secondary lock is in the second position to additionally secure the sliding secondary lock in the second position.

16. The end fitting assembly according to claim 10, wherein the slot extends to a top of the support bracket and the prongs are substantially perpendicular to the slot.

17. The end fitting assembly according to claim 10, wherein the end fitting and the support bracket have cooperating camming surfaces to inwardly deflect the prongs during insertion into the opening through the slot.

18. The end fitting assembly according to claim 10, wherein the end fitting and the support bracket have cooperating abutment surfaces to prevent withdrawal of the end fitting from the opening through the slot.

19. The end fitting assembly according to claim 10, wherein the prongs having inwardly facing tabs engaging the sliding secondary lock when the sliding secondary lock is in the second position.

20. An end fitting assembly for a motion transmitting cable comprising, in combination:
an end fitting having a horizontal central longitudinal axis and a pair of laterally spaced-apart prongs substantially parallel to the central longitudinal axis and resiliently deflectable inward toward one another;
a support bracket having an opening coaxially receiving the end fitting and a slot extending from the opening to a top edge of the support bracket for insertion of the end fitting into the opening;
a sliding secondary lock movable between a first position wherein the prongs are inwardly deflectable and a second position wherein the sliding secondary lock engages the prongs to wedge the prongs into engagement with the support bracket and prevent inward deflection of the prongs; and
wherein the sliding secondary lock has a locking tab engaging the end fitting when the sliding secondary lock is in the second position to secure the sliding secondary lock in the second position.
